(19) United States
(12) Patent Application Publication
(10) Pub. No.: US 2009/0301044 A1
(43) Pub. Date: Dec. 10, 2009

(54) AIR FILTER FRAME

(75) Inventors: William D. Miller, Lancaster, OH (US); David Ray, Bremen, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: SUPERIOR FIBERS LLC, Bremen, OH (US)

(21) Appl. No.: 12/135,442

(22) Filed: Jun. 9, 2008

(51) Int. Cl. B01D 46/52; B01D 46/10; B23P 19/04

(52) U.S. Cl. 55/475; 55/493; 29/700

(57) ABSTRACT

An improved air filter having a frame that permits collapse and compression of the entire filter to save costs associated with transportation and for other advantageous reasons. The ends of the filter frame open to permit collapse of the frame to reduce the volume thereof. The filter frame is made of frame members at opposing frame ends, and each frame member has web panels that open for collapse of the frame, and close for construction of the useful frame. The web panels have legs on opposite lateral edges to form a channel in which filtration media is inserted, and four frame members are attached at opposing ends to form a rectangular frame. The web panels open by removing a temporary fastener, such as adhesive, or by other means.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to air filtration devices, and more particularly to air filters made up of an air-permeable filtration media mounted within a supporting frame.

2. Description Of The Related Art

A common conventional air filter includes a filtration media, such as a non-woven glass or polymer fiber pad, that has a thickness appropriate to the space allowed in the heating and/or cooling system in which the filter will be installed. Surrounding this filtration media is a supporting frame, which can be made of paper, plastic, metal or other materials, and to which the media is attached to prevent the typically flexible media from taking anything other than a substantially planar form before and during use. In a common frame embodiment, four pieces of planar paperboard are each bent along two parallel fold lines to form U-shaped frame channels. The frame pieces are attached together at their ends to form four sides of a rectangular frame that surrounds and retains the filtration media by the media edges being inserted and retained, such as by gluing, into the channels.

The frame of the common air filter is inserted into a slot that is transverse to air flow and just upstream of a furnace's blower. Air drawn into the furnace for heating in the cooler seasons, and for cooling in the warmer seasons, passes through the porous filtration media to filter the air of particles greater than a predetermined size. The filtration of air keeps the operating components of the furnace and blower from being damaged by particulate matter, and serves to “clean” the air in the building in which the furnace operates.

Conventional furnace filters occupy a large external volume, despite the fact that much of the space occupied by the filtration media is filled with air. Transport containers that are filled with air are typically just as costly to transport as a larger number of filters occupying that same space. This causes the cost of transporting filters to be high relative to the weight of conventional filters.

It is known to pleat filtration media, and even to make filters and frames nestable, as shown in U.S. Pat. No. 5,810,898 and U.S. Pat. No. 5,800,588, both to Miller, and both of which are incorporated herein by reference. These patents illustrate an attempt to reduce shipping costs by nesting air filters, but are directed to more costly filters that are too costly to satisfy the needs of all consumers of air filters.

The need exists for a relatively inexpensive air filter that reduces the transportation costs for relatively low cost air filters.

### BRIEF SUMMARY OF THE INVENTION

In accordance with the present invention, there is presented an improved air filter having filtration media mounted in a peripheral supporting frame. The improvement comprises first and second frame members disposed on opposite sides of the media. Each of the first and second frame members is formed of a web with first and second legs mounted on opposite web edges, thereby forming a channel in which the media is mounted. Third and fourth frame members are disposed on opposite sides of the media and attached, at third and fourth frame member ends, to corresponding ends of the first and second frame members. Each of the third and fourth frame members is formed of a web with first and second legs on opposite web edges, thereby forming a channel in which the media is mounted.

The web on the third frame member has at least one web panel pivotably mounted to the first leg, for pivoting from a closed position to an opened position and forming an opening on the third frame member between the first and second legs. Additionally, the web on the fourth frame member has at least one web panel pivotably mounted to the first leg, for pivoting from a closed position to an opened position and forming an opening on the fourth frame member between the first and second legs.

In a preferred embodiment of the invention, the web on the third frame member is the web panel pivotably mounted to the first leg and a second web panel is pivotably mounted to the second leg. Each of the panels is configured to span at least a portion of the opening between the legs of the third frame member. On the opposite side of the filtration media, the web on the fourth frame member is the web panel pivotably mounted to the first leg and a second web panel pivotably mounted to the second leg. Each of the panels is configured to span at least a portion of the opening between the legs of the fourth frame member.

In another preferred embodiment, the web panel of the third frame member extends from the first leg, across the opening to the second leg. The web panel of the fourth frame member extends from the first leg, across the opening to the second leg. The web panel of the third frame member preferably includes a flap panel at an end of the web panel opposite the attachment to the first leg, for inserting into the opening adjacent the second leg. The web panel of the fourth frame member includes a flap panel at an end of the web panel opposite the attachment to the first leg, for inserting into the opening adjacent the second leg.

In still another embodiment of the invention, the air filter has a unitary frame with major perforated top and bottom panels, minor side walls foldably interconnecting corresponding edges of the panels and filtration media mounted between the panels. A first end wall is pivotably mounted at a first end of the frame to one of the panels for pivoting from a closed position to an opened position, thereby forming an opening between the top and bottom panels. Additionally, a second end wall is pivotably mounted at a second end of the frame to one of the panels for pivoting from a closed position to an opened position, thereby forming an opening between the top and bottom panels. The filtration media is preferably pleated.

The invention contemplates an apparatus for collapsing air filters made according to the present invention having filtration media mounted in a peripheral supporting frame between two opposing faces. The apparatus comprises a substrate on which at least one air filter is configured to be seated and a plate spaced from the substrate to form a gap that is at least as large as the air filter. The plate is moveable relative to the substrate. A first pin is disposed adjacent the gap and drivingly linked to means for displacing the first pin toward the gap. Preferably, a first plurality of pins is spaced apart from one another on a first pin member a distance substantially equal to twice an air filter thickness, and a second plurality of pins is preferably spaced apart from one another on a second pin member a distance substantially equal to twice an air filter thickness. By displacing the pin members, and therefore the pins, toward one another, a stack of filters is destabilized.

### BRIEF DESCRIPTION OF THE SEVERAL VIEWS OF THE DRAWINGS

FIG. 1 is a view in perspective illustrating a preferred embodiment of the present invention.

FIG. 2 is a view in perspective illustrating a magnified portion of the preferred embodiment shown in FIG. 1.

FIG. 3 is a view in perspective illustrating the embodiment of FIG. 1 with an end of the filter in a partially opened configuration.

FIG. 4 is a view in perspective illustrating the embodiment of FIG. 1 with an end of the filter in an opened configuration.

FIG. 5 is an end view illustrating the embodiment of FIG. 1 in a partially collapsed state.

FIG. 6 is an end view illustrating the embodiment of FIG. 1 in a further partially collapsed state.

FIG. 7 is a view in perspective illustrating the embodiment of FIG. 1 in a fully collapsed state.

FIG. 8 is a schematic view of an apparatus for collapsing the air filter of the present invention in combination with a unique apparatus for destabilizing a stack of frames that are made according to the present invention.

FIG. 9 is a schematic view of the apparatus of FIG. 8 shown in an advanced state of destabilizing the stack of frames.

FIG. 10 is an end view in perspective illustrating an alternative embodiment of the present invention.

FIG. 11 is an end view in perspective illustrating an alternative embodiment of the present invention.

FIG. 12 is a top view illustrating another alternative embodiment of the present invention.

FIG. 13 is a view in perspective illustrating a magnified portion of the embodiment of FIG. 12.

FIG. 14 is a view in perspective illustrating another magnified portion of the embodiment of FIG. 12.

FIG. 15 is a view in perspective illustrating an alternative embodiment of the present invention in an unassembled state in which a pleated filtration media is mounted in a one-piece frame.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

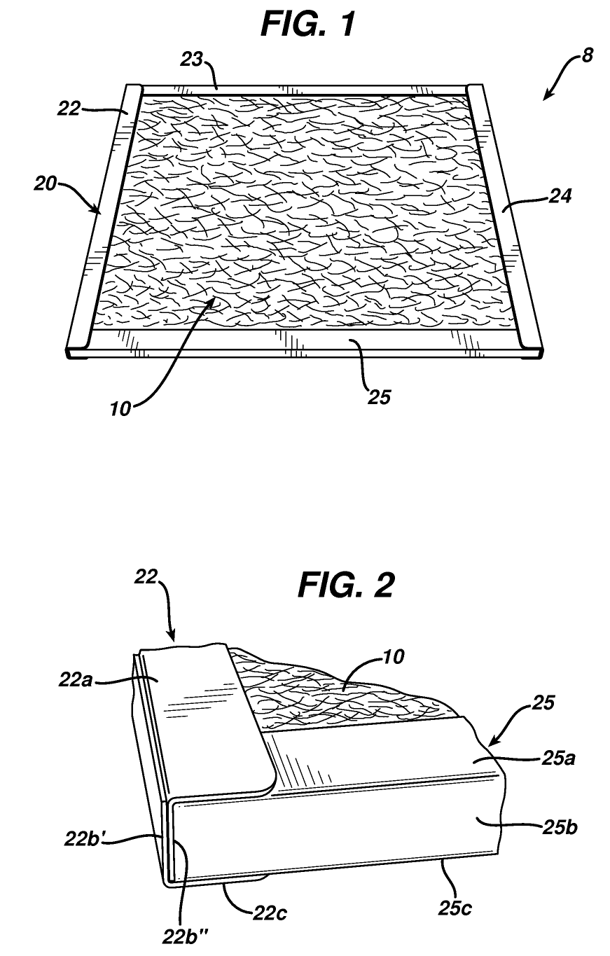

The preferred embodiment of the present invention is illustrated in FIG. 1, in which an air filter 8 includes a filtration media 10 and a frame 20. The air filter 8 has a generally planar shape, although it is contemplated that air filters having a non-planar shape can be made in accordance with the invention. The frame 20 is paperboard, but can be metal (e.g., aluminum), plastic, composite or other materials. The preferred media 10 is nonwoven glass fiber, but alternatives include any compressible media, such as polymer strand fiber mats. The benefit of glass fiber, as will be understood by the person having ordinary skill in the art, is that glass fiber media has “memory”, meaning it returns to, or close to, its original shape after being compressed substantially. Therefore, although polymer fiber filtration media can be used, conventional polymer fibers are not preferred due to their inability to return to their original shape completely. Of course, if polymer materials are developed that have sufficient memory, then it will be apparent to the person having ordinary skill to use such media in place of the materials described above.

The frame 20 consists of four frame members 22, 23, 24 and 25. The frame members 22-25 are formed from folded paperboard, which is conventional for filter frames, consisting of a web and two legs as will be described in more detail below. The unique construction of the filter frame, along with the use of filtration media of the type described, permits the filter to achieve the goal of reduced transportation costs due to the ability to be compressed substantially.

The preferred frame 20 is made of two types of frame members. The frame members 23 and 25, which are disposed on opposite sides of the rectangular filtration media 10 are one type. With reference to FIG. 2, these frame members are made of a web, such as the web 25b, and two legs 25a and 25c (the leg 25c is not visible in FIG. 2, but is identical in all material respects to the leg 25a). The frame member 25 is preferably formed by taking a planar piece of paperboard and bending it along two substantially parallel fold lines to form the folds that define the extreme lateral edges of the web 25b. The fold lines are preferably formed in a conventional manner, such as by cutting partially through the paperboard, thereby forming a hinge connection where the paperboard is locally weaker, and thus a line along which the paperboard preferentially folds to form a corner.

The frame members 22 and 24, which are disposed on opposite sides of the media 10 between the frame members 23 and 25, are the second type of frame member. The frame member 22 is made of a web, which is formed by the web panels 22b′ and 22b″, and two legs 22a and 22c. The frame member 22 is preferably formed by taking two planar pieces of paperboard and, after the pieces of paperboard are joined together as shown in FIG. 2, bending them along two fold lines to form the folds that define the extreme lateral edges of the web panels 22b′ and 22b″. These fold lines are preferably formed in a conventional manner, as described above, along two substantially parallel lines.

Prior art filters have four frame members that are formed by a machine to be essentially identical, the frame members are attached at their ends to one another and a piece of rectangular filtration media is mounted in the channels of the frame members, such as by gluing. The present invention is different from the prior art, at least in part, due to the frame members 22 and 24 being structurally different from the frame members 23 and 25.

The frame member 22 is made from two pieces of paperboard, as noted above, and this construction permits the frame to be collapsed. The separate pieces of the frame member 22 are temporarily joined together, such as by an adhesive, and preferably formed into the U-shaped frame member shown in FIG. 2 in a conventional manner, such as by the machine used to form the frame members 23 and 25. The frame members 22 and 24 are then joined to the frame members 23 and 25 and filtration media is mounted therein in a conventional manner to form the air filter 8 shown in FIG. 1. The air filter 8 is constructed to fit within a furnace slot for conventional air filters, and during use, functions in a manner common to existing air filters. Nevertheless, the air filter 8 has structural features that distinguish it from any existing air filter known to Applicant.

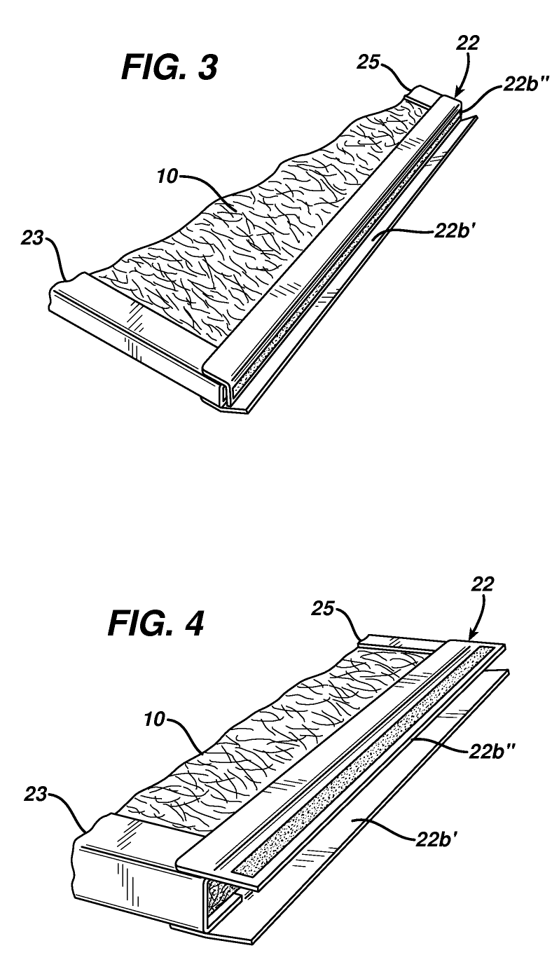

The air filter 8 in FIG. 1 has only a temporary bond between the web panels 22b′ and 22b″, which temporary bond was formed in order to permit attachment of the frame members to other frame members and to the filter media 10. Prior to transporting the filter 8, and preferably immediately after construction is complete, the temporary bond joining the pieces of paperboard that form the web panels 22b′ and 22b″ is broken, as shown in FIG. 3, thereby permitting opening of the ends of the filter 8 as shown in FIG. 4. Because the frame member 24 is substantially identical to the frame member 22, the frame member 24 can also be similarly opened. Opening of the frame members 22 and 24 can be accomplished manually, such as by hand, or using a flat blade that is inserted into the space between the web panels 22b′ and 22b″ and moving the blade relative to the filter 8 or the filter 8 relative to the blade.

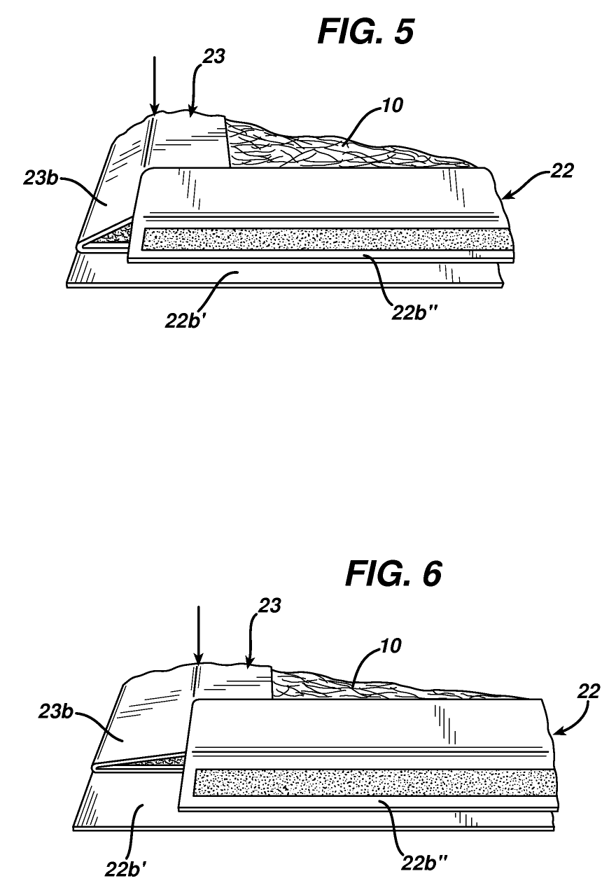

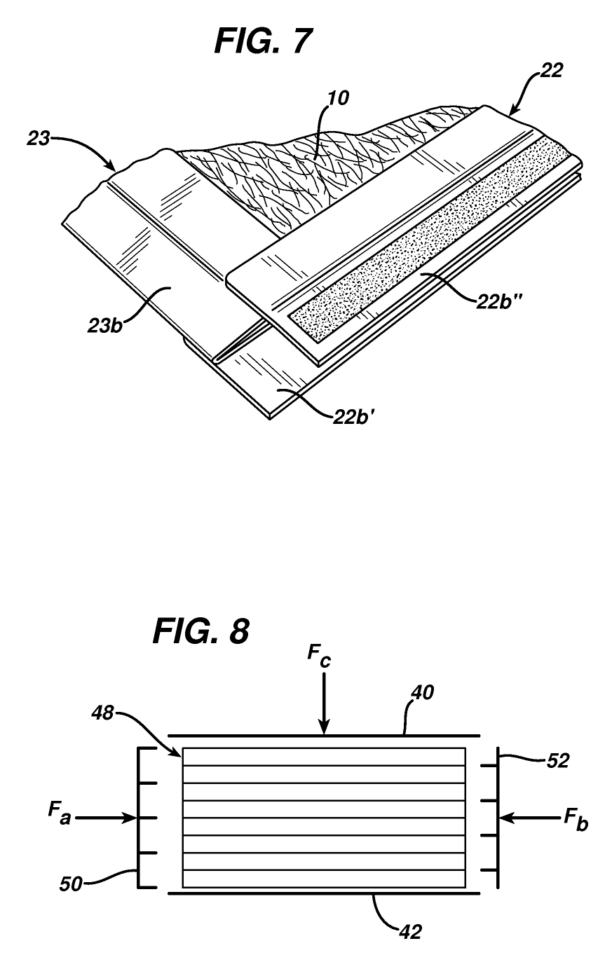

When both ends of the frame 20 are opened, the frame 20 and media 10 can be collapsed and then compressed by a force transverse to the plane of the media 10. This force causes the legs of the members 23 and 25 and their respective web to move relative to one another along the folds, as shown in FIG. 5 and then in FIG. 6. The frame 20 is collapsed in this manner until the angle between one leg of each frame member and a respective web is substantially 0 degrees, and the angle between the other leg of each frame member and the respective web is substantially 180 degrees. This is illustrated in FIG. 7 where the frame members 22-25 have been collapsed to substantially twice the thickness of the paperboard of which the members 22-25 are made.

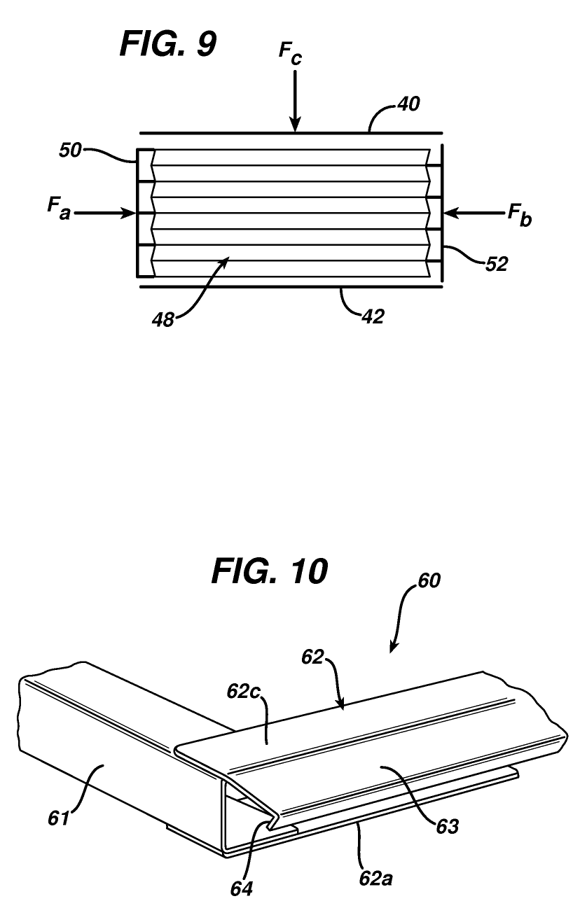

The means by which the frame is collapsed can vary, but a preferred means for collapsing the frame 20 is shown schematically in FIG. 8. The plates 40 and 42 are mounted substantially parallel to one another with a plurality of air filters 48 disposed on the plate 42. The air filters 48 are made according to the present invention, and are substantially identical to the air filter 8 shown in FIG. 1. The plate 40 remains substantially parallel to the plate 42 while the plate 40 is displaced toward the plate 42 under the compressive force F_{c} that is applied to the plate 40. The force F_{c} is preferably applied by a conventional linear prime mover, such as a pneumatic or hydraulic ram, and tends to collapse the air filters 48 in the manner described above for the filter 8. As the force F_{c} is applied to the air filters 48, the pin members 50 and 52 are displaced laterally toward the air filters 48 by the forces Fₐ and F_{b}, which are also applied by linear prime movers. The forces Fₐ and F_{b} cause the pins on the pin members 50 to destabilize the frames of the air filters 48, thereby causing the legs and webs of the frames to bend at the folds, as described above for the air filter 8, and as shown in FIG. 9.

Thus, the lower face of the top filter, and the lower face of every other filter under the top filter, moves to the left in the FIG. 9 illustration due to the lateral force applied by the pins of the pin member 52. Similarly, the upper face of the second filter from the top, which seats against the lower face of the top filter, and the upper face of every other filter under it, moves in the same direction due to the lateral force applied by the same pins. However, the upper face of the top filter, and the upper face of every other filter under it, moves in the opposite direction (to the right) due to the lateral force applied by the pin member 50. Similarly, the lower face of the second filter from the top, and the lower face of every other filter under it, moves to the right due to the lateral force applied by the pins of the pin member 50. This causes the stack of filters 48 to collapse evenly in the manner of an accordion between the plates 40 and 42, thereby permitting further compression by the plates 40 and 42.

After the stack of air filters 48 collapses, it occupies a substantially smaller space than prior to collapse. If it is desirable to further reduce the space, the stack of filters 48 can be further compressed by inserting the filters 48 into a sealed vacuum bag and removing air from the bag. This vacuum compression following mechanical collapse is the preferred method of packaging the collapsed frames of the present invention, although it will become apparent that other means of collapsing and compressing can be implemented. The air filters made according to the invention can then be transported in a much smaller volume to an end user. Because air filters of the type described herein are still relatively light, even in their compressed state, the cost to transport the much thinner, compressed filters is appreciably less than in the uncompressed state. Such filters can be reduced in thickness to about ten percent of their original thickness or less.

Once the collapsed and preferably vacuum-packaged air filter 8 is received by the end user, he or she removes the filter 8 from the vacuum packaging, which is preferably a flexible plastic film, and permits the compressed media to return to near its original thickness. The user next assembles the frame 20 to the configuration shown in FIG. 1. The end user does so, in the preferred embodiment, by manually manipulating the legs of the frame members 23 and 25 to a substantially perpendicular orientation relative to their respective webs, as shown in FIG. 1, and then fastens the web panel 22b′ to the web panel 22b″, and repeats this step for the substantially identical web panels of the frame member 24. This fastening can be accomplished by adhesive, adhesive tape and/or staples or other fasteners. In a preferred embodiment, the web panel 22b′ has a strip of double-sided tape covered by a peel away strip, or tacky adhesive covered by a peel away strip, and the end user simply removes the peel away strip to expose the adhesive surface, and then places the web panel 22b″ against the adhesive. This process is repeated at the opposite frame member 24. Upon completion, the end user has a useful air filter 8, which can be purchased for a substantial cost savings over conventional air filters.

In the preferred embodiment, a temporary adhesive is placed between the web panels 22b′ and 22b″ during manufacture of the frame 20, and a tacky adhesive with a peel away strip is also placed between the web panels 22b′ and 22b″. The tacky adhesive is covered with the peel away strip during manufacturing, and the tacky adhesive is spaced far enough from the temporary adhesive to avoid interference with, and is not permitted to adhere to, the opposing panel until the end user removes the peel away strip.

It will be understood that the present invention can be manufactured to have frame members that differ in structure from the frame members 22 and 24 shown in the preferred embodiment, but which function substantially the same. For example, the frame 60 shown in FIG. 10 has a frame member 62, which is mounted to a U-shaped frame member 61. The frame member 62 has a web panel 63 that extends across the opening formed between the legs 62a and 62c of the frame member 62 from a hinge at the attached edge of the web panel 63. A flap panel 64 extends at an angle along a fold from the web panel 63 at the edge of the web panel 63 opposite the leg 62c, and can insert into the opening against the leg 62a. The flap panel 64 frictionally engages the leg 62a, thereby holding the web panel 63 in a closed configuration (not shown). Adhesive can be applied to, or fasteners can be inserted through, the flap panel 64 and/or the leg 62a to hold the flap panel 64 in the closed configuration, temporarily during manufacture, and then permanently for the end user. A frame member on the opposite end of the frame 60 as the frame member 62 can be an identical, or any equivalent, structure.

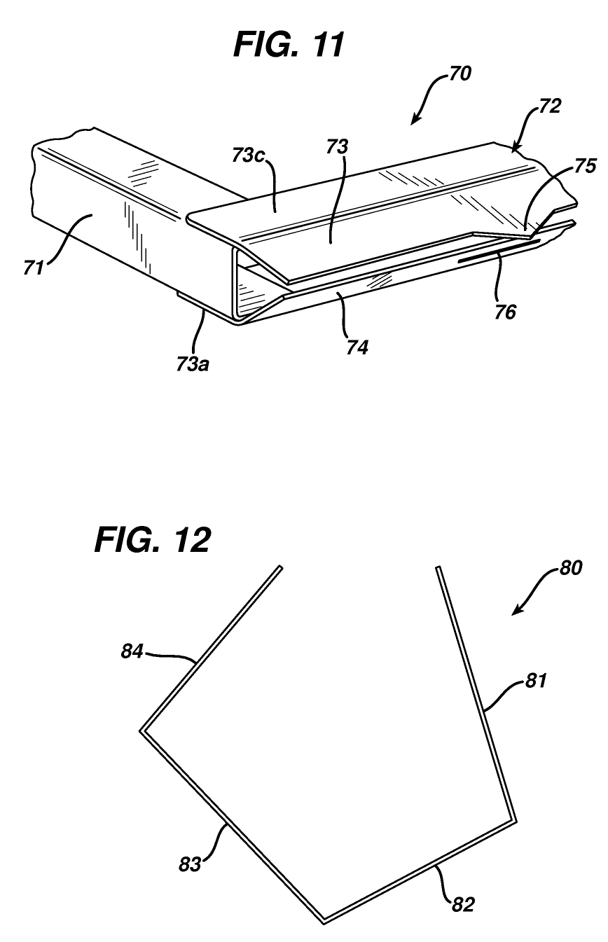

In still another alternative embodiment, the frame 70 shown in FIG. 11 has a frame member 71 that is mounted to a frame member 72. Each of the web panels 73 and 74 extends partially across the opening between the legs 73a and 73c. The web panel 73 has a tab 75 that inserts into the slot 76 formed on the web panel 74 when the web panels 73 and 74 are substantially parallel to one another. This mechanical connection between the web panels 73 and 74 holds the web panels in a closed configuration. Adhesive can be applied to, or fasteners can be inserted through, the web panels to temporarily and then permanently bond the two together as described above. The frame member on the opposite end of the frame 70 as the frame member 71 can be an identical, or any equivalent, structure.

The air filter frame described above as the preferred embodiment and its alternatives are made of four frame members that are separate pieces and are joined together at opposite ends to form the frame at overlapping regions of the frame members. Of course, it is possible to form the frame from contiguous paperboard or other material, as in the case with so-called “wraparound” filter frames. Such a frame 80 is shown in FIG. 12 made up of the frame members 81, 82, 83 and 84, which are joined to one another at folds formed by cutting partially through the material of which the frame 80 is made, such as paperboard. The frame members 81 and 84 can be mounted to one another, as described below, by a tab and adhesive.

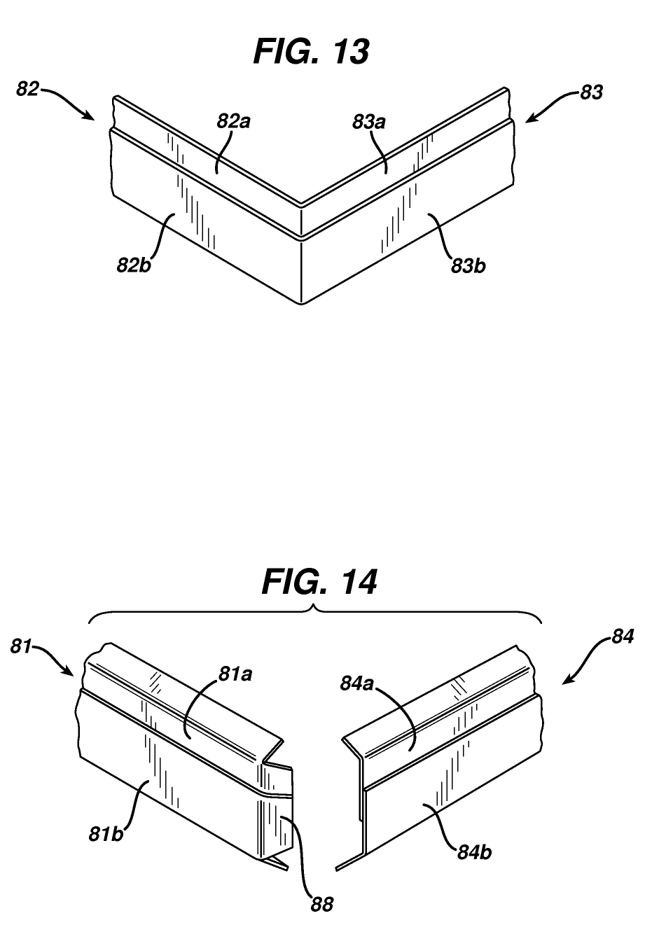

The frame members 81-84 of the wraparound frame 80 are formed from two pieces of paperboard bonded together at an overlapping region as described below. FIG. 13 shows a corner between the frame members 82 and 83. The corner is a fold formed by partially cutting the material of the frame, as is described above for other such folds. The first strip makes up the pieces 82a and 83a of the frame members 82 and 83, respectively. At the junction between the frame members 81 and 84, as shown in FIG. 14, the pieces 81a and 84a that make up a portion of the frame members 81 and 84, respectively, are better illustrated with the overlap of the pieces 81b and 84b. The legs, which are hidden in FIG. 13, are illustrated in FIG. 14, and are shown relative to the fold that is formed between the web and the legs. The tab 88 extends from the frame member 81 to the frame member 84. The tab is adhesively or otherwise fastened to the web of the frame member 84, thereby forming the frame 80.

Once the filtration media is mounted in the assembled frame 80, the panels of the webs of two opposing frame members are opened as described above in relation to the frame 20, which permits the frame 80 to be collapsed as described above. It may be necessary to also cut the legs at the corners in order to permit complete opening.

It is preferred that the bonding of the two pieces of paperboard that make up the contiguous frame members of the frame 80 be temporary on the frame members that will be opened and permanent on the frame members that will remain closed. One contemplated means by which this can be accomplished is by using different types of adhesive in the different regions of the paperboard strips, such as by alternating the glue between regions according to the type of frame member each region will become. Alternatively, different amounts of glue can be placed on different regions, in accordance with the ultimate purpose of the particular region. In any case, it is contemplated that the two strips of paperboard can be joined together and formed into a frame in a conventional manner, and the person having ordinary skill will understand from the description herein that many other configurations can be used while incorporating the present invention.

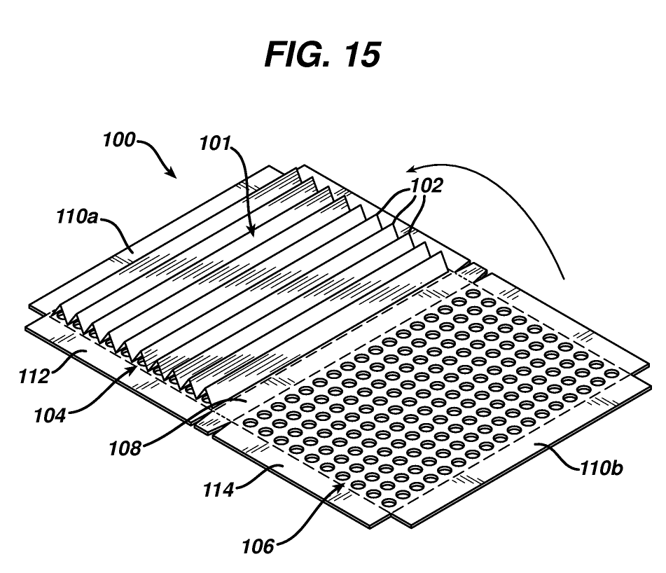

The present invention is described above in relation to an air filter having a frame that is made of a plurality of pieces. As an alternative embodiment of the invention, a so-called “die cut” filter frame can also incorporate the present invention, as shown in FIG. 15. The air filter 100 has a filtration media 101 formed into a plurality of pleated ridges 102. The media 101 is pleated in a conventional manner and adhered at the lower edges of each valley to a perforated bottom panel 104. A perforated top panel 106 folds along a minor side wall 108 and is adhered to the top of the pleated ridges 102 with the filtration media 101 mounted between the panels. The panels 110a and 110b form a minor sidewall when adhered together.

The flap 112 forms a first end wall pivotably mounted at a first end of the filter 100 to the panel 104 and the flap 114 forms a second end wall pivotably mounted at a first end of the panel 106. The flaps 112 and 114 pivot from a closed position to an opened position when the filter 100 is assembled, thereby forming an opening between the top and bottom panels. An identical structure is mounted at the opposite end of the filter 100, thereby forming an opening between the top and bottom panels 104 and 106. With the FIG. 15 embodiment, opening of the ends of the filter 100 permits collapse of the filter 100 by pivoting at the joints where the peaks and valleys of the pleats are adhered to the top and bottom panels 104 and 106. Upon relaxation of the compression force, the filter 100 is constructed by attaching the flaps 112 and 114, and the identical flaps on the opposite end of the filter 100. It is contemplated that a tacky adhesive will have to be placed on the inner face of the innermost flap on each end of the filter 100 in order to adhere to the ends of each of the pleated ridges 102. A second tacky adhesive will be applied to the other flap at each end to adhere the flaps together during assembly. Each tacky adhesive will preferably have a peel away strip to cover the adhesive until assembly begins.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved air filter having filtration media mounted in a peripheral supporting frame, the improvement comprising:
(a) first and second frame members disposed on opposite sides of the media, each of the first and second frame members formed of a web with first and second legs mounted on opposite web edges, thereby forming a channel in which the media is mounted;
(b) third and fourth frame members disposed on opposite sides of the media and attached, at third and fourth frame member ends, to corresponding ends of the first and second frame members, wherein each of the third and fourth frame members is formed of a web with first and second legs on opposite web edges, thereby forming a channel in which the media is mounted;
(c) wherein the web on the third frame member has at least one web panel pivotably mounted to the first leg, for pivoting from a closed position to an opened position and forming an opening on the third frame member between the first and second legs; and
(d) wherein the web on the fourth frame member has at least one web panel pivotably mounted to the first leg, for pivoting from a closed position to an opened position and forming an opening on the fourth frame member between the first and second legs.

2. The improved air filter in accordance with claim 1, wherein the web on the third frame member comprises said at least one web panel pivotably mounted to the first leg and a second web panel pivotably mounted to the second leg, each of said panels configured to span at least a portion of the opening between the legs of the third frame member.

3. The improved air filter in accordance with claim 2, wherein the web on the fourth frame member comprises said at least one web panel pivotably mounted to the first leg and a second web panel pivotably mounted to the second leg, each of said panels configured to span at least a portion of the opening between the legs of the fourth frame member.

4. The improved air filter in accordance with claim 2, wherein the web panels of the third frame member are configured to connect together to close the opening between the legs of the third frame member.

5. The improved air filter in accordance with claim 4, wherein the web panels of the fourth frame member are configured to connect together to close the opening between the legs of the fourth frame member.

6. The improved air filter in accordance with claim 1, wherein said at least one web panel of the third frame member extends from the first leg, across the opening to the second leg.

7. The improved air filter in accordance with claim 6, wherein said at least one web panel of the fourth frame member extends from the first leg, across the opening to the second leg.

8. The improved air filter in accordance with claim 7, wherein the web panel of the third frame member further comprises a flap panel at an end of the web panel opposite the attachment to the first leg, for inserting into the opening adjacent the second leg.

9. The improved air filter in accordance with claim 8, wherein the web panel of the fourth frame member further comprises a flap panel at an end of the web panel opposite the attachment to the first leg, for inserting into the opening adjacent the second leg.

10. The improved air filter in accordance with claim 1, wherein the third and fourth frame member ends attach to the corresponding ends of the first and second frame members at overlapping regions of the legs of the frame members.

11. The improved air filter in accordance with claim 1, wherein the third and fourth frame member ends attach to the corresponding ends of the first and second frame members at a hinge between the first and second frame members, a hinge between the second and third frame members, and a hinge between the third and fourth frame members, and the fourth and first frame members attach by an overlapping region.

12. An improved air filter having a unitary frame with major perforated top and bottom panels, minor side walls foldably interconnecting corresponding edges of the panels with filtration media mounted between the panels, the improvement comprising:
(a) a first end wall pivotably mounted at a first end of the frame to one of the panels, for pivoting from a closed position to an opened position, thereby forming an opening between the top and bottom panels; and
(b) a second end wall pivotably mounted at a second end of the frame to one of the panels, for pivoting from a closed position to an opened position, thereby forming an opening between the top and bottom panels;
wherein the filtration media is pleated.

13. The improved air filter in accordance with claim 12, further comprising a second end wall pivotably mounted at the first end of the frame to one of the panels, for pivoting from a closed position to an opened position, each of the walls configured to span at least a portion of the opening between the panels.

14. The improved air filter in accordance with claim 13, further comprising a second end wall pivotably mounted at the second end of the frame to one of the panels, for pivoting from a closed position to an opened position, each of the walls configured to span at least a portion of the opening between the panels.

15. The improved air filter in accordance with claim 12, wherein the first end wall at the first end extends from one of the panels, across the opening to the second panel.

16. The improved air filter in accordance with claim 15, wherein the first wall at the second end extends from one of the panels, across the opening to the second panel.

17. The improved air filter in accordance with claim 16, wherein the first end wall of the first end further comprises a flap at an end of the end wall opposite the attachment to the panel, for inserting into the opening adjacent the opposite panel.

18. The improved air filter in accordance with claim 17, wherein the first end wall of the second end further comprises a flap at an end of the end wall opposite the attachment to the panel, for inserting into the opening adjacent the opposite panel.

19. An apparatus for collapsing an air filter having filtration media mounted in a peripheral supporting frame between two opposing faces, the apparatus comprising:
(a) a substrate on which at least one air filter is configured to be seated;
(b) a plate spaced from the substrate to form a gap that is at least as large as the air filter, wherein the plate is moveable relative to the substrate; and
(c) at least a first pin disposed adjacent the gap and drivingly linked to means for displacing the first pin toward the gap.

20. The apparatus in accordance with claim 19, further comprising at least a second pin disposed adjacent the gap oppositely to the first pin and drivingly linked to means for displacing the second pin toward the gap.

21. The apparatus in accordance with claim 20, wherein said at least a first pin further comprises a first plurality of pins spaced apart from one another on a first pin member a distance substantially equal to twice an air filter thickness, and wherein said at least a second pin further comprises a second plurality of pins spaced apart from one another on a second pin member a distance substantially equal to twice an air filter thickness.

22. A method of collapsing an air filter having filtration media mounted in a peripheral supporting frame between first and second opposing faces, the method comprising:
(a) disposing a plurality of air filters on a substrate;
(b) spacing a plate from the substrate to form a gap that is at least as large as the plurality of air filters;
(c) disposing a first plurality of pins on a first pin member spaced a distance substantially equal to twice an air filter thickness, and disposing the first plurality of pins adjacent the gap;
(d) disposing a second plurality of pins on a second pin member spaced a distance substantially equal to twice an air filter thickness, and disposing the second plurality of pins adjacent the gap on an opposite side of the gap from the first plurality of pins;
(e) moving the plate relative to the air filters; and
(c) driving the first pin member and the second pin member toward the gap.

23. The method in accordance with claim 22, further comprising aligning at least one of the pins of the first pin member with an edge of one of the plurality of the filters adjacent the first filter face, and aligning at least one of the pins of the second pin member with an opposite edge of said filter adjacent the second filter face.
